(19) United States
(12) Patent Application Publication
(10) Pub. No.: US 2017/0270407 A1
(43) Pub. Date: Sep. 21, 2017

(54) GLOBALLY NORMALIZED NEURAL NETWORKS

(71) Applicant: Google Inc., Mountain View, CA (US)

(72) Inventors: Christopher Alberti, New York, NY (US); Aliaksei Severyn, Zurich (CH); Daniel Andor, New York, NY (US); Slav Petrov, New York, NY (US); Kuzman Ganchev Ganchev, Forest Hills, NY (US); David Joseph Weiss, Philadelphia, PA (US); Michael John Collins, New York, NY (US); Alessandro Presta, San Francisco, CA (US)

(21) Appl. No.: 15/407,470

(22) Filed: Jan. 17, 2017

Related U.S. Application Data
(60) Provisional application No. 62/310,491, filed on Mar. 18, 2016.

(51) Int. Cl. G06N 3/08; G06N 3/04

(52) U.S. Cl. CPC G06N 3/08; G06N 3/04

(57) ABSTRACT

A method includes training a neural network having parameters on training data, in which the neural network receives an input state and processes the input state to generate a respective score for each decision in a set of decisions. The method includes receiving training data including training text sequences and, for each training text sequence, a corresponding gold decision sequence. The method includes training the neural network on the training data to determine trained values of parameters of the neural network. Training the neural network includes for each training text sequence: maintaining a beam of candidate decision sequences for the training text sequence, updating each candidate decision sequence by adding one decision at a time, determining that a gold candidate decision sequence matching a prefix of the gold decision sequence has dropped out of the beam, and in response, performing an iteration of gradient descent to optimize an objective function.

### CROSS-REFERENCE TO RELATED APPLICATION

This application claims priority to U.S. Provisional Application Ser. No. 62/310,491, filed on Mar. 18, 2016. The disclosure of the prior application is considered part of and is incorporated by reference in the disclosure of this application.

### BACKGROUND

This specification relates to natural language processing using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that processes a text sequence to generate a decision sequence using a globally normalized neural network.

In general, one innovative aspect of the subject matter described in this specification can be embodied in methods of training a neural network having parameters on training data, in which the neural network is configured to receive an input state and process the input state to generate a respective score for each decision in a set of decisions. The methods include the actions of receiving first training data, the first training data comprising a plurality of training text sequences and, for each training text sequence, a corresponding gold decision sequence. The methods include the actions of training the neural network on the first training data to determine trained values of the parameters of the neural network from first values of the parameters of the neural network. Training the neural network includes for each training text sequence in the first training data: maintaining a beam of a predetermined number of candidate predicted decision sequences for the training text sequence, updating each candidate predicted decision sequence in the beam by adding one decision at a time to each candidate predicted decision sequence using scores generated by the neural network in accordance with current values of the parameters of the neural network, determining, after each time that a decision has been added to each of the candidate predicted decision sequences, that a gold candidate predicted decision sequence matching a prefix of the gold decision sequence corresponding to the training text sequence has dropped out of the beam, and in response to determining that the gold candidate predicted decision sequence has dropped out of the beam, performing an iteration of gradient descent to optimize an objective function that depends on the gold candidate predicted decision sequence and on the candidate predicted sequences currently in the beam.

The foregoing and other embodiments can each optionally include one or more of the following features, alone or in combination. The methods can include the actions of receiving second training data, the second training data comprising multiple training text sequences and, for each training text sequence, a corresponding gold decision sequence, and pre-training the neural network on the second training data to determine the first values of the parameters of the neural network from initial values of the parameters of the neural network by optimizing an objective function that depends on, for each training text sequence, scores generated by the neural network for decisions in the gold decision sequence corresponding to the training text sequence and on a local normalization for the scores generated for the decisions in the gold decision sequence. The neural network can be a globally normalized neural network. The set of decisions can be a set of possible parse elements of a dependency parse, and the gold decision sequence can a dependency parse of the corresponding training text sequence. The set of decisions can be a set of possible part of speech tags, and the gold decision sequence can be a sequence that includes a respective part of speech tag for each word in the corresponding training text sequence. The set of decisions can include a keep label indicating that the word should be included in a compressed representation of the input text sequence and a drop label indicating that the word should not be included in the compressed representation, and in which the gold decision sequence is a sequence that includes a respective keep label or drop label for each word in the corresponding training text sequence. If the gold candidate predicted decision sequence has not dropped out of the beam after the candidate predicted sequences have been finalized, the methods can further include the actions of performing an iteration of gradient descent to optimize an objective function that depends on the gold decision sequence and on the finalized candidate predicted sequences.

Another innovative aspect of the subject matter described in this specification can be embodied in one or more computer-readable storage media encoded with instructions that, when executed by one or more computers, cause the one or more computers to perform operations to train a neural network having parameters on training data, in which the neural network is configured to receive an input state and process the input state to generate a respective score for each decision in a set of decisions. The operations include receiving first training data, the first training data comprising a plurality of training text sequences and, for each training text sequence, a corresponding gold decision sequence; and training the neural network on the first training data to determine trained values of the parameters of the neural network from first values of the parameters of the neural network. The training includes, for each training text sequence in the first training data: maintaining a beam of a predetermined number of candidate predicted decision sequences for the training text sequence; updating each candidate predicted decision sequence in the beam by adding one decision at a time to each candidate predicted decision sequence using scores generated by the neural network in accordance with current values of the parameters of the neural network; determining, after each time that a decision has been added to each of the candidate predicted decision sequences, that a gold candidate predicted decision sequence matching a prefix of the gold decision sequence corresponding to the training text sequence has dropped out of the beam; and in response to determining that the gold candidate predicted decision sequence has dropped out of the beam, performing an iteration of gradient descent to optimize an objective function that depends on the gold candidate predicted decision sequence and on the candidate predicted sequences currently in the beam.

The foregoing and other embodiments can each optionally include one or more of the following features, alone or in combination. The operations can further include: receiving second training data, the second training data comprising a plurality of training text sequences and, for each training text sequence, a corresponding gold decision sequence; and pre-training the neural network on the second training data to determine the first values of the parameters of the neural network from initial values of the parameters of the neural network by optimizing an objective function that depends on, for each training text sequence, scores generated by the neural network for decisions in the gold decision sequence corresponding to the training text sequence and on a local normalization for the scores generated for the decisions in the gold decision sequence. The neural network can be a globally normalized neural network. The set of decisions can be a set of possible parse elements of a dependency parse, and the gold decision sequence can be a dependency parse of the corresponding training text sequence. The set of decisions can be a set of possible part of speech tags, and the gold decision sequence can be a sequence that includes a respective part of speech tag for each word in the corresponding training text sequence. The set of decisions can include a keep label indicating that the word should be included in a compressed representation of the input text sequence and a drop label indicating that the word should not be included in the compressed representation, and the gold decision sequence can be a sequence that includes a respective keep label or drop label for each word in the corresponding training text sequence. The operations can include: if the gold candidate predicted decision sequence has not dropped out of the beam after the candidate predicted sequences have been finalized, performing an iteration of gradient descent to optimize an objective function that depends on the gold decision sequence and on the finalized candidate predicted sequences.

Another innovate aspect of the subject matter described in this specification can be embodied in a system for generating a decision sequence for an input text sequence, the decision sequence including a plurality of output decision. The system includes a neural network configured to receive an input state, and process the input state to generate a respective score for each decision in a set of decisions. The system further includes a subsystem configured to maintain a beam of a predetermined number of candidate decision sequences for the input text sequence. For each output decision in the decision sequence, the subsystem is configured to repeatedly perform the following operations. For each candidate decision sequence currently in the beam, the subsystem provides a state representing candidate decision sequence as input to the neural network and obtain from the neural network a respective score for each of a plurality of new candidate decision sequences, each new candidate decision sequence having a respective allowed decisions from a set of allowed decisions added to the current candidate decision sequence, updates the beam to include only a predetermined number of new candidate decision sequences with highest scores according to the scores obtained from the neural network, and for each new candidate decision sequence in the updated beam, generates a respective state representing the new candidate decision sequence. After the last output decision in the decision sequence, the subsystem selects from the candidate decision sequences in the beam a candidate decision sequence with a highest score as the decision sequence for the input text sequence.

The foregoing and other embodiments can each optionally include one or more of the following features, alone or in combination. The set of decisions can be a set of possible parse elements of a dependency parse, and the decision sequence can be a dependency parse of the text sequence. The set of decisions can be a set of possible part of speech tags, and the decision sequence is a sequence that includes a respective part of speech tag for each word in the text sequence. The set of decisions can include a keep label indicating that a word should be included in a compressed representation of the input text sequence and a drop label indicating that the word should not be included in the compressed representation, and wherein the decision sequence is a sequence that includes a respective keep label or drop label for each word in the text sequence.

Another innovative aspect of the subject matter described in this specification can be embodied in one or more computer-readable storage media encoded with instructions that, when executed by one or more computers, cause the one or more computers to implement the first system described above.

Particular embodiments of the subject matter described in this specification can be implemented so as to realize one or more of the following advantages. A globally normalized neural network as described in this specification can be used to achieve good results on natural language processing tasks, e.g., part-of-speech tagging, dependency parsing, and sentence compression, more effectively and cost-efficiently than existing neural network models. For example, a globally normalized neural network can be a feed-forward neural network that operates on a transition system and can be used to achieve comparable or better accuracies than existing neural network model (e.g., recurrent models) at a fraction of computational cost. In addition, a globally normalized neural network can avoid the label bias problem that applies to many existing neural network models.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example machine learning system that includes a neural network.

FIG. 2 is a flow diagram of an example process for generating a decision sequence from an input text sequence using a neural network.

FIG. 3 is a flow diagram of an example process for training a neural network on training data.

FIG. 4 is a flow diagram of an example process for training the neural network on each training text sequence in the training data.

Like reference numbers and designations in the various drawings indicate like elements.

### DETAILED DESCRIPTION

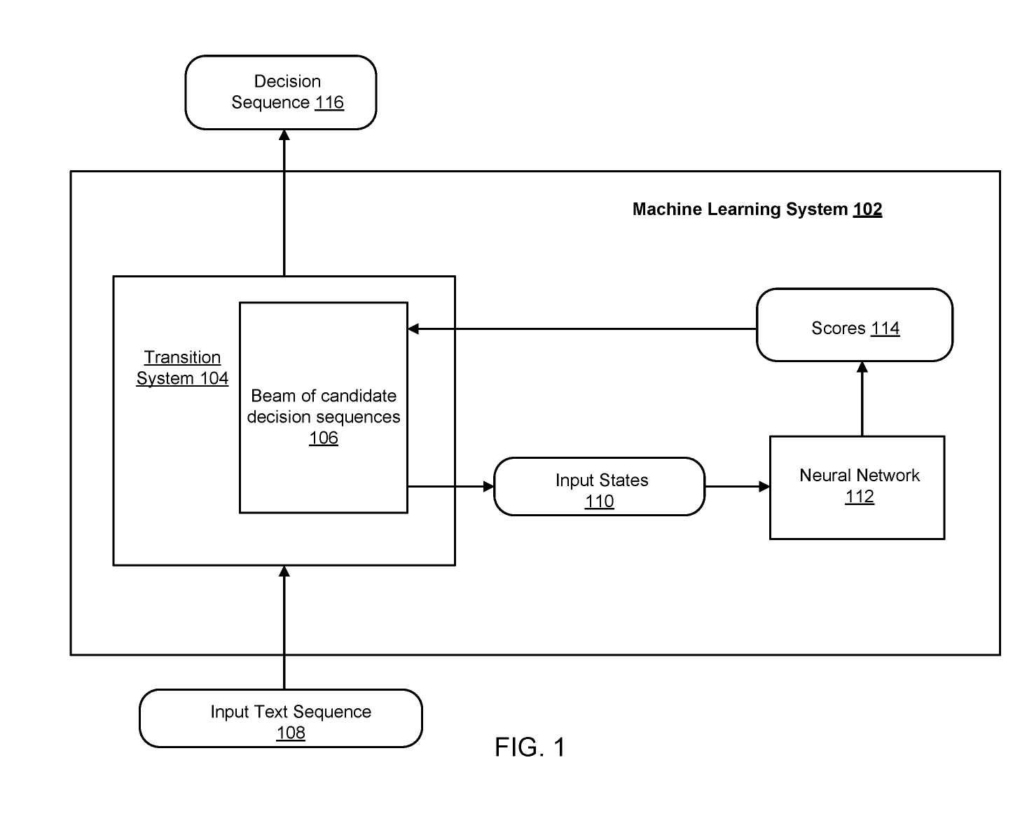

FIG. 1 is a block diagram of an example machine learning system 102. The machine learning system 102 is an example of a system implemented as computer programs on one or more computers in one or more locations, in which the systems, components, and techniques described below can be implemented.

The machine learning system 102 includes a transition system 104 and a neural network 112 and is configured to receive an input text sequence 108 and process the input text sequence 108 to generate a decision sequence 116 for the input text sequence 108. The input text sequence 108 is a sequence of words and, optionally, punctuation marks in a particular natural language, e.g., a sentence, a sentence fragment, or another multi-word sequence.

A decision sequence is a sequence of decisions. For example, the decisions in the sequence may be part of speech tags for words in the input text sequence.

As another example, the decisions may be keep or drop labels for the words in the input text sequence. A keep label indicates that the word should be included in a compressed representation of the input text sequence and a drop label indicates that the word should not be included in the compressed representation

As another example, the decisions may be parse elements of a dependency parse, so that the decision sequence is a dependency parse of the input text sequence. Generally, a dependency parse represents a syntactic structure of a text sequence according to a context-free grammar. The decision sequence may be a linearized representation of a dependency parse that may be generated by traversing the dependency parse in a depth-first traversal order.

Generally, the neural network 112 is a neural network that is configured to receive an input state and process the input state to generate a respective score for each decision in the set of decisions by virtue of having been trained to minimize an objective function during the training process. The input state is an encoding of a current decision sequence. In some cases, the neural network also receives the text sequence as input and processes the text sequence and the state to generate the decision scores. In other cases, the state also encodes the text sequence in addition to the current decision sequence.

In some cases, the objective function is expressed by a product of conditional probability distribution functions. Each conditional probability distribution function represents a probability of a next decision given past decisions. Each conditional probability distribution function is represented by a set of conditional scores. The conditional scores can be greater than 1.0 and thus are normalized by a local normalization term to have a valid conditional probability distribution function. There is one local normalization term per each conditional probability distribution function. Specifically, in these cases, the objective function is defined as follows:

$$\begin{matrix}{p}_{L} ( {d}_{1 : n} ) = {\prod }_{j = 1}^{n} p ( {d}_{j} \vert {d}_{1 \text{:} j - 1} ; θ ) \\ = \frac{exp {\sum }_{j = 1}^{n} ρ ( {d}_{1 \text{:} j - 1} , {d}_{j} ; θ )}{{\prod }_{j = 1}^{n} {Z}_{L} ( {d}_{1 \text{:} j - 1} ; θ )} .\end{matrix} \qquad ( 1 )$$

where
p_{L}(d_{1:n}) is a probability of a sequence of decisions of d_{1:n} given an input text sequence denoted as x_{1:n},
p(dⱼ|d_{1:j-1};θ) is a conditional probability distribution over decision sequence dⱼ given previous decision sequences d_{1:j-1}, vector θ that contains model parameters, and the input text sequence x_{1:n},
ρ(d_{1:j-1},dⱼ;θ) is a conditional score over decision sequence dⱼ given previous decision sequences d_{1:j-1}, vector θ that contains model parameters, and the input text sequence x_{1:n}, and
Z_{L}(d_{1:j-1};θ) is a local normalization term.

In some other cases, the objective function is expressed by a joint probability distribution function of the entire decision sequences. In these other cases, the objective function can be referred to as a Conditional Random Field (CRF) objective function. The joint probability distribution function is represented as a set of scores. These scores can be greater than 1.0 and thus are normalized by a global normalization term to have a valid joint probability distribution function. The global normalization term is shared by all decisions in the decision sequences. More specifically, in these other cases, the CRF objective function is defined as follows:

$$\begin{matrix}{p}_{G} ( {d}_{1 : n} ) = \frac{exp {\sum }_{j = 1}^{n} ρ ( {d}_{1 \text{:} j - 1} , {d}_{j} ; θ )}{{Z}_{G} ( θ )} , & ( 2 ) \\ where & \\ {Z}_{G} ( θ ) = {\sum }_{{d}_{1 \text{:} n}^{′} ∈ {𝒟}_{n}} exp {\sum }_{j = 1}^{n} ρ ( {d}_{1 \text{:} j - 1}^{′} , {d}_{j}^{′} ; θ ) & \end{matrix}$$

and where
p_{G}(d_{1:n}) is a join probability distribution of a sequence of decisions of d_{1:n} given the input text sequence x_{1:n},
ρ(d_{1:j-1},dⱼ;θ) is a joint score over decision sequence dⱼ given previous decision sequences d_{1:j-1}, vector θ that contains model parameters, and the input text sequence x_{1:n},
Z_{G}(θ) is a global normalization term, and
Dₙ is the set of all allowed decision sequences of length n.

In these other cases, the neural network 112 is called a globally normalized neural network, as it is configured to maximize the CRF objective function. By maintaining the global normalization term, the neural network 112 can avoid the label bias problem that existing neural networks present. More specifically, in many cases, a neural network is expected to be able to revise an earlier decision, when later information becomes available that rules out an earlier incorrect decision. The label bias problem means that some existing neural networks such as locally normalized networks have a weak ability to revise earlier decisions.

The transition system 104 maintains a set of states that includes a special start state, a set of allowed decisions for each state in the set of states, and a transition function that maps each state and a decision from the set of allowed decisions for each state to a new state.

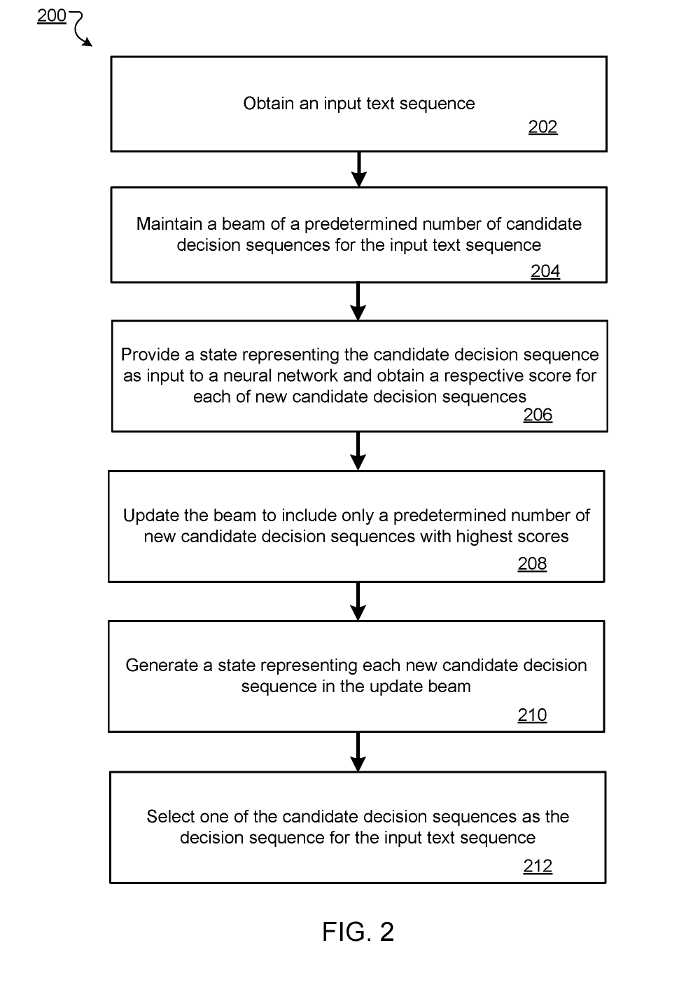

In particular, a state encodes the entire of history of decisions that are currently in a decision sequence. In some cases, each state can only be reached by a unique decision sequence. Thus, in these cases, decision sequences and states can be used interchangeably. Because a state encodes the entire of history of decisions, the special start state is empty and the size of the state expands over time. For example, in part-of-speech tagging, consider a sentence “John is a doctor.” The special start state is “Empty.” When the special start state is the current state, then the set of allowed decisions for the current state can be {Noun, Verb}. Thus, there are two possible states “Empty, Noun” and “Empty, Verb” for the next state of the current state. The transition system 104 can decide a next decision from the set of allowed decisions. For example, the transition system 104 decides that the next decision is Noun. Then the next state is “Empty, Noun.” The transition system 104 can use a transition function to map the current state and the decided next decision for the current state to a new state, e.g., the first state “Empty, Noun.” The transition system 104 can perform this process repeatedly to generate subsequent states, e.g., the second state can be “Empty, Noun, Verb,” the third state can be “Empty, Noun, Verb, Article,” and the fourth state can be “Empty, Noun, Verb, Article, Noun.” This decision making process is described in more detail below with reference to FIGS. 2-4.

During processing of the input text sequence 108, the transition system 104 maintains a beam 106 of a predetermined number of candidate decision sequences for the input text sequence 108. The transition system 104 is configured to receive the input text sequence 108 and to define a special start state of the transition system 104 based on the received input text sequence 108 (e.g., based on a word such as the first word in the input text sequence).

Generally, during the processing of the input text sequence 108 and for a current state of a decision sequence, the transition system 104 applies the transition function on the current state to generate new states as input states 110 to the neural network 112. The neural network 112 is configured to process input states 110 to generate respective scores 114 for the input states 110. The transition system 104 is then configured to update the beam 106 using the scores generated by the neural network 112. After the candidate decision sequences are finalized, the transition system 104 is configured to select one of the candidate decision sequences in the beam 106 as the decision sequence 116 for the input text sequence 108. The process of generating the decision sequence 116 for the input text sequence 108 is described in more detail below with reference to FIG. 2.

FIG. 2 is a flow diagram of an example process 200 for generating a decision sequence from an input text sequence. For convenience, the process 200 will be described as being performed by a system of one or more computers located in one or more locations. For example, a machine learning system, e.g., the machine learning system 102 of FIG. 1, appropriately programmed in accordance with this specification, can perform the process 200.

The system obtains an input text sequence, e.g., a sentence, including multiple words (step 202).

The system maintains a beam of candidate decision sequences for the obtained input text sequence (step 204).

As part of generating the decision sequence for the input text sequence, the system repeatedly performs steps 206-210 for each output decision in the decision sequence.

For each candidate decision sequence currently in the beam, the system provides a state representing the candidate decision sequence as input to the neural network (e.g., the neural network 112 of FIG. 1) and obtains from the neural network a respective score for each of a plurality of new candidate decision sequences, each new candidate decision sequence having a respective allowed decision in a set of allowed decisions added to the current candidate decision sequence (step 206). That is, the system determines the allowed decisions for the current state of the candidate decision sequence and uses the neural network to obtain a respective score for each of the allowed decisions.

The system updates the beam to include only a predetermined number of new candidate decision sequences with the highest scores according to the scores obtained from the neural network (step 208). That is, the system replaces the sequences in the beam with the predetermined number of new candidate decision sequences.

The system generates a respective new state for each new candidate decision sequence in the beam (step 210). In particular, for a given new candidate decision sequence generated by adding a given decision to a given candidate decision sequence, the system generates the new state by applying the transition function to the current state for the given candidate decision sequence and the given decision that was added to the given candidate decision sequence to generate the new decision sequence.

The system continues repeating steps 206-210 until the candidate decision sequences in the beam are finalized. In particular, the system determines the number of decisions that should be included in the decision sequence based on the input sequence and determines that the candidate decision sequences are finalized when the candidate decision sequences include the determined number of decisions. For example, when the decisions are part of speech tags, the decision sequence will include the same number of decisions as there are words in the input sequence. As another example, when the decisions are keep or drop labels, the decision sequence will also include the same number of decisions as there are words in the input sequence. As another example, when the decisions are parse elements, the decision sequence will include a multiple of the number of words in the input sequence, e.g., twice as many decisions as there are words in the input sequence.

After the candidate decision sequences in the beam are finalized, the system selects from the candidate decision sequences in the beam with the highest score as the decision sequence for the input text sequence (step 212).

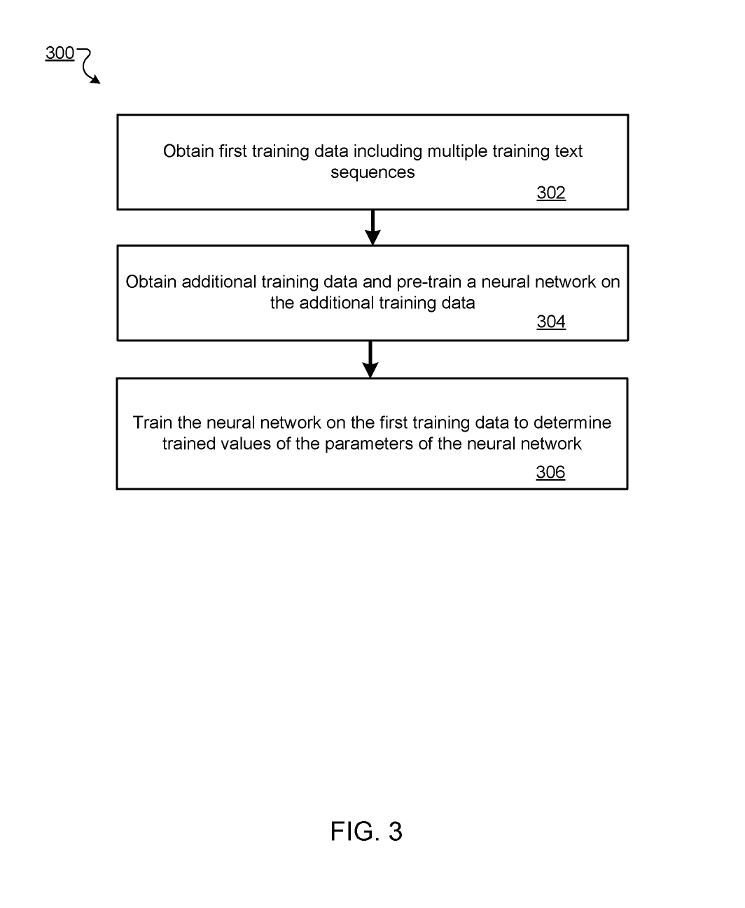

FIG. 3 is a flow diagram of an example process 300 for training a neural network on training data. For convenience, the process 300 will be described as being performed by a system of one or more computers located in one or more locations. For example, a machine learning system, e.g., the machine learning system 102 of FIG. 1, appropriately programmed in accordance with this specification, can perform the process 300.

To train the neural network, the system receives first training data that includes training text sequences and, for each training text sequence, a corresponding gold decision sequence (step 302). Generally, the gold decision sequence is a sequence that includes multiple decisions, with each decision being selected from a set of possible decisions.

In some cases, the set of decisions is a set of possible parse elements of a dependency parse. In these cases, the gold decision sequence is a dependency parse of the corresponding training text sequence.

In some cases, the set of decisions is a set of possible part of speech tags. In these cases, the gold decision sequence is a sequence that includes a respective part of speech tag for each word in the corresponding training text sequence.

In some other cases, the set of decisions includes a keep label indicating that the word should be included in a compressed representation of the input text sequence and a drop label indicating that the word should not be included in the compressed representation. In these other cases, the gold decision sequence is a sequence that includes a respective keep label or drop label for each word in the corresponding training text sequence.

Optionally, the system can first obtain additional training data and pre-train the neural network on the additional training data (step 304). In particular, the system can receive second training data that includes multiple training text sequences and for each training text sequence, a corresponding gold decision sequence. The second training data can be the same as or different from the second training data.

The system can pre-train the neural network on the second training data to determine the first values of the parameters of the neural network from initial values of the parameters of the neural network by optimizing an objective function that depends on, for each training text sequence, scores generated by the neural network for decisions in the gold decision sequence corresponding to the training text sequence and on a local normalization for the scores generated for the decisions in the gold decision sequence (step 304). In particular, in some cases, the system can perform a gradient descent on the negative log-likelihood of the second training data using an objective function that locally normalizes the neural network, e.g. the function (1) presented above.

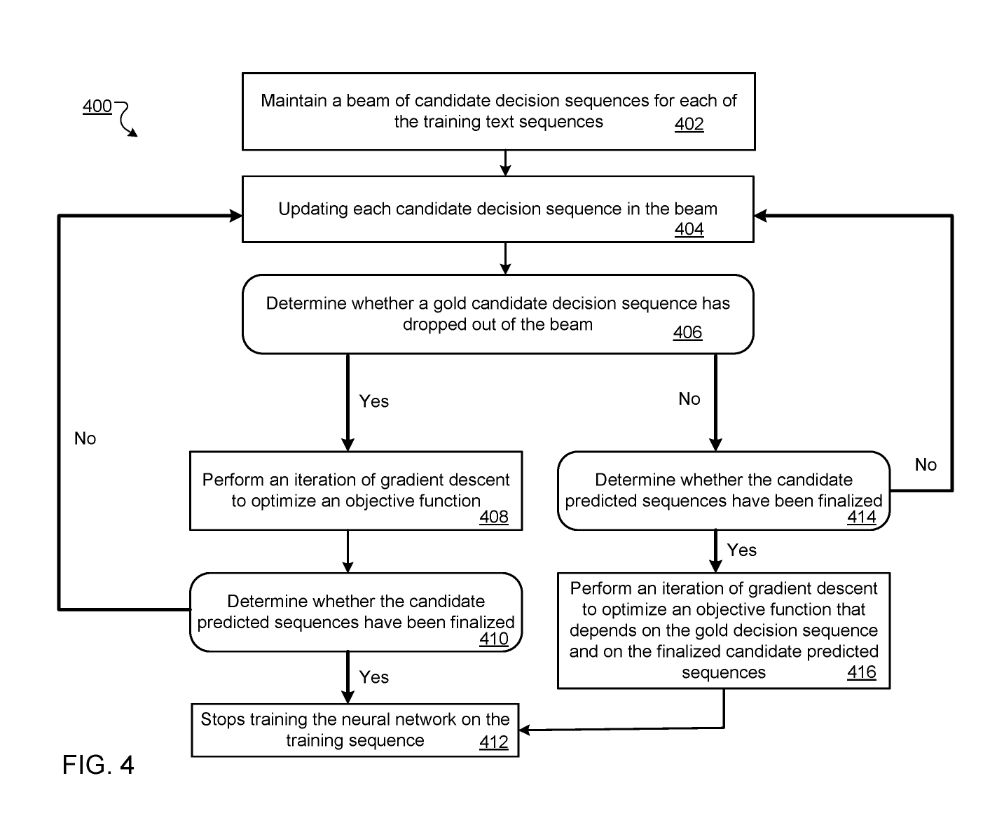

The system then trains the neural network on the first training data to determine trained values of the parameters of the neural network from the first values of the parameters of the neural network (step 306). In particular, the system performs a training process on each of the training text sequences in the first training data. Performing the training process on a given training text sequence is described in detail below with reference to FIG. 4.

FIG. 4 is a flow diagram of an example training process 400 for training the neural network on a training text sequence in the first training data. For convenience, the process 400 will also be described as being performed by a system of one or more computers located in one or more locations. For example, a machine learning system, e.g., the machine learning system 102 of FIG. 1, appropriately programmed in accordance with this specification, can perform the training process 400.

The system maintains a beam of a predetermined number of candidate predicted decision sequences for the training text sequence (step 402).

The system then updates each candidate predicted decision sequence in the beam by adding one decision at a time to each candidate predicted decision sequence using scores generated by the neural network in accordance with current values of the parameters of the neural network as described above with reference to FIG. 2 (step 404).

After each time that a decision has been added to each of the candidate predicted decision sequences, the system determines whether a gold candidate predicted decision sequence matching a prefix of the gold decision sequence corresponding to the training text sequence has dropped out of the beam (step 406). That is, the gold decision sequence is truncated after the current time step and compared with the candidate predicted decision sequences currently in the beam. If there is a match, the gold decision sequence has not dropped out of the beam. If there is no match, the gold decision sequence has dropped out of the beam.

In response to determining that the gold candidate predicted decision sequence has dropped out of the beam, the system performs an iteration of gradient descent to optimize an objective function that depends on the gold candidate predicted decision sequence and on the candidate predicted sequences currently in the beam (step 408). The gradient descent step is taken on the following objective:

$${L}_{global - beam} ( {d}_{1 \text{:} j}^{*} ; θ ) = - {\sum }_{i = 1}^{j} ρ ( {d}_{1 \text{:} i - 1}^{*} , {d}_{i}^{*} ; θ ) + ln {\sum }_{{d}_{1 \text{:} j}^{′} ∈ {ℬ}_{j}} exp {\sum }_{i = 1}^{j} ρ ( {d}_{1 \text{:} i - 1}^{′} , {d}_{i}^{′} ; θ ) \qquad ( 3 )$$

where
ρ(d*_{1:i-1},d*ᵢ;θ) is a joint score over gold candidate decision sequence d*ᵢ given previous gold candidate decision sequences d*_{1:i-1}, vector θ that contains model parameters, and the input text sequence x, and
ρ(d′_{1:i-1},d′ᵢ;θ) is a joint score over candidate decision sequence d′ᵢ in the beam given previous candidate decision sequences d′_{1:i-1} in the beam, vector θ that contains model parameters, and the input text sequence x, and
Bⱼ is a set of all candidate decision sequences in the beam when the gold candidate decision sequence was dropped, and
d*_{1:j} is the prefix of the gold decision sequence corresponding to the current training text sequence.

The system then determines whether the candidate predicted sequences have been finalized (step 410). If the candidate predicted sequences have been finalized, the system stops training the neural network on the training sequence (step 412). If the candidate predicted sequences have not been finalized, the system resets the beam to include the gold candidate predicted decision sequence. The system then goes back to the step 404 to update each candidate predicted decision sequence in the beam.

In response to determining that the gold candidate predicted decision sequence has not dropped out of the beam, the system then determines whether the candidate predicted sequences have been finalized (step 414).

If the candidate predicted sequences have been finalized and the gold candidate predicted decision sequence is still in the beam, the system performs an iteration of gradient descent to optimize an objective function that depends on the gold decision sequence and on the finalized candidate predicted sequences (step 416). That is, when the gold candidate predicted decision sequence remains in the beam throughout the process, a gradient descent step is taken on the same objective as denoted in Eq. (3) above, but using the entire gold decision sequence instead of the prefix and the set Bₙ of all of the candidate decision sequence that remain in the beam at the end of the process. The system then stops training the neural network on the training sequence (step 412).

If the candidate predicted sequences have not been finalized, the system then goes back to step 404 to update each candidate predicted decision sequence in the beam.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method of training a neural network having parameters on training data,
wherein the neural network is configured to receive an input state and process the input state to generate a respective score for each decision in a set of decisions, and wherein the method comprises:
receiving first training data, the first training data comprising a plurality of training text sequences and, for each training text sequence, a corresponding gold decision sequence; and
training the neural network on the first training data to determine trained values of the parameters of the neural network from first values of the parameters of the neural network, comprising, for each training text sequence in the first training data:
maintaining a beam of a predetermined number of candidate predicted decision sequences for the training text sequence;
updating each candidate predicted decision sequence in the beam by adding one decision at a time to each candidate predicted decision sequence using scores generated by the neural network in accordance with current values of the parameters of the neural network;
determining, after each time that a decision has been added to each of the candidate predicted decision sequences, that a gold candidate predicted decision sequence matching a prefix of the gold decision sequence corresponding to the training text sequence has dropped out of the beam; and
in response to determining that the gold candidate predicted decision sequence has dropped out of the beam, performing an iteration of gradient descent to optimize an objective function that depends on the gold candidate predicted decision sequence and on the candidate predicted sequences currently in the beam.

2. The method of claim 1, further comprising:
receiving second training data, the second training data comprising a plurality of training text sequences and, for each training text sequence, a corresponding gold decision sequence; and
pre-training the neural network on the second training data to determine the first values of the parameters of the neural network from initial values of the parameters of the neural network by optimizing an objective function that depends on, for each training text sequence, scores generated by the neural network for decisions in the gold decision sequence corresponding to the training text sequence and on a local normalization for the scores generated for the decisions in the gold decision sequence.

3. The method of claim 1, wherein the neural network is a globally normalized neural network.

4. The method of claim 1, wherein the set of decisions is a set of possible parse elements of a dependency parse, and wherein the gold decision sequence is a dependency parse of the corresponding training text sequence.

5. The method of claim 1, wherein the set of decisions is a set of possible part of speech tags, and wherein the gold decision sequence is a sequence that includes a respective part of speech tag for each word in the corresponding training text sequence.

6. The method of claim 1, wherein the set of decisions includes a keep label indicating that the word should be included in a compressed representation of the input text sequence and a drop label indicating that the word should not be included in the compressed representation, and wherein the gold decision sequence is a sequence that includes a respective keep label or drop label for each word in the corresponding training text sequence.

7. The method of claim 1, further comprising: if the gold candidate predicted decision sequence has not dropped out of the beam after the candidate predicted sequences have been finalized, performing an iteration of gradient descent to optimize an objective function that depends on the gold decision sequence and on the finalized candidate predicted sequences.

8. One or more computer-readable storage media encoded with instructions that, when executed by one or more computers, cause the one or more computers to perform operations to train a neural network having parameters on training data, wherein the neural network is configured to receive an input state and process the input state to generate a respective score for each decision in a set of decisions, and wherein the operations comprise:
receiving first training data, the first training data comprising a plurality of training text sequences and, for each training text sequence, a corresponding gold decision sequence; and
training the neural network on the first training data to determine trained values of the parameters of the neural network from first values of the parameters of the neural network, comprising, for each training text sequence in the first training data:
maintaining a beam of a predetermined number of candidate predicted decision sequences for the training text sequence;
updating each candidate predicted decision sequence in the beam by adding one decision at a time to each candidate predicted decision sequence using scores generated by the neural network in accordance with current values of the parameters of the neural network;
determining, after each time that a decision has been added to each of the candidate predicted decision sequences, that a gold candidate predicted decision sequence matching a prefix of the gold decision sequence corresponding to the training text sequence has dropped out of the beam; and
in response to determining that the gold candidate predicted decision sequence has dropped out of the beam, performing an iteration of gradient descent to optimize an objective function that depends on the gold candidate predicted decision sequence and on the candidate predicted sequences currently in the beam.

9. The one or more computer-readable storage media of claim 8, wherein the operations further comprising:
receiving second training data, the second training data comprising a plurality of training text sequences and, for each training text sequence, a corresponding gold decision sequence; and
pre-training the neural network on the second training data to determine the first values of the parameters of the neural network from initial values of the parameters of the neural network by optimizing an objective function that depends on, for each training text sequence, scores generated by the neural network for decisions in the gold decision sequence corresponding to the training text sequence and on a local normalization for the scores generated for the decisions in the gold decision sequence.

10. The one or more computer-readable storage media of claim 8, wherein the neural network is a globally normalized neural network.

11. The one or more computer readable storage media of claim 8, wherein the set of decisions is a set of possible parse elements of a dependency parse, and wherein the gold decision sequence is a dependency parse of the corresponding training text sequence.

12. The one or more computer readable storage media of claim 8, wherein the set of decisions is a set of possible part of speech tags, and wherein the gold decision sequence is a sequence that includes a respective part of speech tag for each word in the corresponding training text sequence.

13. The one or more computer readable storage media of claim 8, wherein the set of decisions includes a keep label indicating that the word should be included in a compressed representation of the input text sequence and a drop label indicating that the word should not be included in the compressed representation, and wherein the gold decision sequence is a sequence that includes a respective keep label or drop label for each word in the corresponding training text sequence.

14. The one or more computer readable storage media of claim 8, wherein the operations further comprising: if the gold candidate predicted decision sequence has not dropped out of the beam after the candidate predicted sequences have been finalized, performing an iteration of gradient descent to optimize an objective function that depends on the gold decision sequence and on the finalized candidate predicted sequences.

15. A system for generating a decision sequence for an input text sequence, the decision sequence comprising a plurality of output decisions, and the system comprising:
a neural network configured to:
receive an input state, and
process the input state to generate a respective score for each decision in a set of decisions; and
a subsystem configured to:
maintain a beam of a predetermined number of candidate decision sequences for the input text sequence;
for each output decision in the decision sequence:
for each candidate decision sequence currently in the beam:
provide a state representing the candidate decision sequence as input to the neural network and obtain from the neural network a respective score for each of a plurality of new candidate decision sequences, each new candidate decision sequence having a respective allowed decision from a set of allowed decisions added to the current candidate decision sequence,
update the beam to include only a predetermined number of new candidate decision sequences with highest scores according to the scores obtained from the neural network;
for each new candidate decision sequence in the updated beam, generate a respective state representing the new candidate decision sequence; and
after the last output decision in the decision sequence, select from the candidate decision sequences in the beam a candidate decision sequence with a highest score as the decision sequence for the input text sequence.

16. The system of claim 15, wherein the set of decisions is a set of possible parse elements of a dependency parse, and wherein the decision sequence is a dependency parse of the text sequence.

17. The system of claim 15, wherein the set of decisions is a set of possible part of speech tags, and wherein the decision sequence is a sequence that includes a respective part of speech tag for each word in the text sequence.

18. The system of claim 15, wherein the set of decisions includes a keep label indicating that a word should be included in a compressed representation of the input text sequence and a drop label indicating that the word should not be included in the compressed representation, and wherein the decision sequence is a sequence that includes a respective keep label or drop label for each word in the text sequence.
